(19) United States
(12) Patent Application Publication
(10) Pub. No.: US 2009/0176021 A1
(43) Pub. Date: Jul. 9, 2009

(54) Adhesive roller and method for use

(76) Inventor: Monica Lee Walsh, Huntersville, NC (US)

Correspondence Address: TAFT, STETTINIUS & HOLLISTER LLP, SUITE 1800, 425 WALNUT STREET, CINCINNATI, OH, 45202-3957, US

(21) Appl. No.: 12/008,032

(22) Filed: Jan. 8, 2008

(51) Int. Cl. B05D 3/12; B29D 22/00

(52) U.S. Cl. 427/299; 428/34.1

(57) ABSTRACT

A roller cover having an adhesive surface. Embodiments may provide tear-away, disposable sheets having an adhesive coating. The adhesive may be adapted to remove loose material from a substrate prior to the application of stain or paint to the substrate. The roller cover may be sized to fit industry standard paint rollers.

### BACKGROUND OF THE INVENTION

This invention relates generally to the field of rollers and roller covers used to apply paint and other finishes and, more particularly, to roller covers having an adhesive exterior. More specifically, the invention relates to a roller cover including an adhesive exterior that is adapted to remove debris from a surface in preparation for application of a finish and methods for using such a roller.

### BRIEF SUMMARY OF THE INVENTION

Embodiments of the present invention may include a roller cover having an adhesive surface. Embodiments may provide tear-away, disposable sheets having an adhesive coating. The adhesive may be adapted to remove loose material from a substrate prior to the application of stain or paint to the substrate. The roller cover may be sized to fit industry standard paint rollers.

In a first aspect, a method of preparing a surface for receiving a finish may include the steps of providing a substrate having a surface; providing a roller assembly, the roller assembly including a handle attached to a rotatable roller, the rotatable roller having an adhesive exterior; rolling the adhesive exterior of the roller over at least a portion of the surface; and applying a finish to the surface.

In a detailed embodiment of the first aspect, the rotatable roller may include a plurality of layers of adhesive sheets and each sheet may include a backing and an adhesive coating. The method may further include the steps of, after the step of rolling the adhesive exterior of the roller over the surface, removing at least one of the layers of adhesive sheets from the rotatable roller and rolling the adhesive exterior of the roller over another portion of the surface. The adhesive exterior of the roller may include an adhesive adapted to retain loose particles present on the surface. The adhesive may be adapted to release from paint that is properly adhered to the surface. The surface of the substrate may have been painted and/or may include unfinished wood. The substrate may be, for example and without limitation, a wall, a ceiling, and/or a piece of furniture. The step of applying a finish to the surface may include removing the adhesive exterior of the roller from the roller assembly; installing a paint roller cover on the roller assembly; and applying the finish to the surface using the paint roller cover. The adhesive exterior of the roller may include a portion having a triangular cross section adapted for rolling in a corner.

In a second aspect, embodiments of an adhesive roller cover may include a cylinder; a plurality of removable backing sheets disposed on the cylinder in a layered fashion, each backing sheet having a first surface and a second surface; and a layer of adhesive substantially covering the first surface of each backing sheet; wherein the cylinder is adapted to releaseably couple with a roller portion of a paint roller frame. In a detailed embodiment of the second aspect, the plurality of backing sheets may be disposed on the cylinder in a spiral-wound fashion and/or a straight-wound fashion.

In a third aspect, a method of finishing a surface may include the steps of providing a substrate having a surface; providing a roller assembly having a handle; providing an adhesive roller adapted to releasably couple with the roller assembly, the adhesive roller including a plurality of layers of adhesive-coated sheets, the adhesive coating being disposed on the outside of each of the sheets and the sheets being separated by perforations; providing a roller cover; providing a surface finish; coupling the adhesive roller with the roller assembly; rolling the adhesive roller on the surface to remove loose material from the surface; removing the adhesive roller from the roller assembly; installing the roller cover; and applying the surface finish to the surface using the roller assembly with the roller cover.

In a detailed embodiment of the third aspect, the step of rolling the adhesive roller on the surface to remove loose material on the surface may include removing at least one of the layers of adhesive-coated sheets to expose an unused adhesive-coated sheet. The surface of the substrate may have been painted and/or may include unfinished wood. The substrate may be, for example and without limitation, a wall, a ceiling, and/or a piece of furniture. The method may further include the steps of removing the roller cover from the roller assembly; installing the adhesive roller onto the roller assembly; and rolling the adhesive roller on the surface to remove loose material from the surface. Further still, the method may include the steps of, subsequent to applying the surface finish, providing an abrasive comprising at least one of the group consisting of sand paper and steel wool; and abrading the surface finish using the abrasive.

### BRIEF DESCRIPTION OF THE SEVERAL VIEWS OF THE DRAWING

The detailed description particularly refers to the accompanying Figures in which:

FIG. 1 is an elevation view of an exemplary embodiment adhesive roller installed on a roller frame; and

FIG. 2 is a perspective view of an exemplary embodiment adhesive roller.

### DETAILED DESCRIPTION OF THE INVENTION

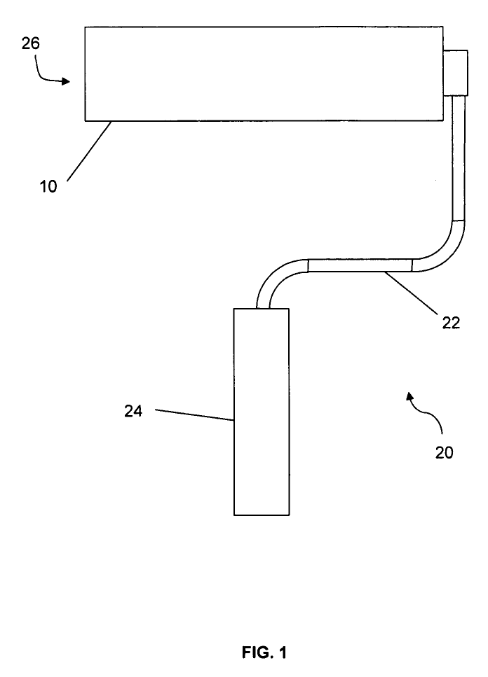

As shown in FIG. 1, an embodiment of an adhesive roller 10 may be adapted for use on an industry standard roller assembly 20. Such roller assemblies 20 typically include a frame member 22, a handle 24, and a roller portion 26. The roller portion 26 is typically adapted to receive a roller cover in such a way that the roller cover is rotatable as it is rolled on a surface. The present invention adhesive roller 10 takes the place of the roller cover typically used to apply a finish to a surface.

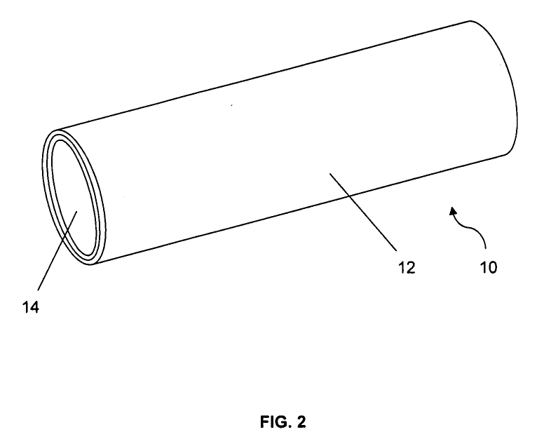

As shown in FIG. 2, an embodiment of an adhesive roller 10 may include a core 14 and an adhesive portion 12. In an exemplary embodiment, the core 14 may comprise a cardboard tube. It is within the scope of the invention to utilize other materials for the core. For example and without limitation, the core 14 may be constructed from plastic, PVC, and/or other appropriate materials.

In an exemplary embodiment, the adhesive portion 12 may comprise a plurality of tear-away adhesive sheets, each sheet having a backing and an adhesive coating on its outward-facing surface. In an exemplary embodiment, the backing may be constructed of paper, although other suitable materials (such as, but not limited to, plastics or nonwoven fabrics) may be used. The sheets may be wound in a spiral manner, such that each sheet generally forms a helix around the core 14. In a specific exemplary embodiment, each sheet may comprise an approximately 2″ wide helix. In other embodiments, the tear-away sheets may be wound around the core 14 in a straight wound (convolute) manner. The sheets may be perforated such that one sheet at a time may be removed from the adhesive roller 10.

The adhesive roller 10 provides an adhesive outward-facing surface. The adhesive must be sufficiently tacky to remove loose material from a surface. At the same time, the adhesive must not be so tacky that it unnecessarily removes excessive material from the surface. For example, it may be desirable for the roller to leave properly-attached paint on a surface while removing loose paint chips and/or dust. Exemplary embodiments of the invention include adhesive-coated sheets that, when tested using a standard rolling ball adhesive tackiness test, allow the ball to roll less than approximately 20 cm. Also, exemplary embodiments include an adhesive coating that, when tested using a shear-hang test, yields not less than 3 mm in one hour for a 25 mm×100 mm sample using a 500 g weight.

The adhesive outer surface of the adhesive roller 10 may be rolled on a substrate to remove loose material present on the substrate. For example, the adhesive roller 10 may be rolled on wall to remove loose material in preparation for applying a finish, such as paint. In another exemplary application, an adhesive roller 10 may be rolled over piece of furniture prior to application of a finish such as a stain, varnish, urethane, etc. It is within the scope of the invention to utilize the adhesive roller in preparation for applying any finish to any surface, including fixed surfaces such as walls, ceilings, and floors, as well as movable surfaces such as furniture or artwork.

Further, it is within the scope of the invention to utilize an adhesive roller 10 various times during a finishing process. For example, a user may sand a piece of furniture and then use an adhesive roller to remove the dust resulting from the sanding. After application of a first finish, the user may again use an adhesive roller to remove loose material in preparation for applying a second finish. A user may utilize an adhesive roller to remove loose material resulting from abrasion of a surface finish between coats, such as from sanding or using steel wool.

For example and without limitation, embodiments of the invention may be adapted to fit on 3″, 4″, 9.5″, 12″, and 18″ industry standard roller frames. Other embodiments of the invention may be adapted to fit on other rollers such as industry standard mini rollers, for example. Further, embodiments of the invention may be adapted for use on specialty rollers such as corner rollers having portions with triangular cross sections. It is within the scope of the invention to adapt embodiments of the adhesive roller for use with other roller assemblies having sizes, shapes, and arrangements different from an industry standard roller assembly.

While exemplary embodiments of the invention have been set forth above for the purpose of disclosure, modifications of the disclosed embodiments of the invention as well as other embodiments thereof may occur to those skilled in the art. Accordingly, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the stated advantages or objects of the invention disclosed herein to fall within the scope of the claims, since inherent and/or unforeseen advantages of the present invention may exist even though they may not have been explicitly discussed herein.

What is claimed is:

1. A method of preparing a surface for receiving a finish comprising the steps of:
providing a substrate having a surface;
providing a roller assembly, the roller assembly including a handle attached to a rotatable roller, the rotatable roller having an adhesive exterior;
rolling the adhesive exterior of the roller over at least a portion of the surface; and
applying a finish to the surface.

2. The method of claim 1, wherein the rotatable roller includes a plurality of layers of adhesive sheets, each sheet including a backing and an adhesive coating.

3. The method of claim 2, further comprising the steps of, after the step of rolling the adhesive exterior of the roller over the surface, removing at least one of the plurality of layers of adhesive sheets from the rotatable roller and rolling the adhesive exterior of the roller over another portion of the surface.

4. The method of claim 3, wherein the adhesive exterior of the roller includes an adhesive adapted to retain loose particles present on the surface.

5. The method of claim 4, wherein the adhesive of the adhesive exterior of the roller is adapted to release from paint that is properly adhered to the surface.

6. The method of claim 1, wherein the surface of the substrate has been painted.

7. The method of claim 1, wherein the surface of the substrate is unfinished wood.

8. The method of claim 1, wherein the substrate is at least one of the group consisting of a wall, a ceiling, and a piece of furniture.

9. The method of claim 1, wherein the step of applying a finish to the surface includes the steps of:
removing the adhesive exterior of the roller from the roller assembly;
installing a paint roller cover on the roller assembly; and
applying the finish to the surface using the paint roller cover.

10. The method of claim 1, wherein the adhesive exterior of the roller includes a portion having a triangular cross section adapted for rolling in a corner.

11. An adhesive roller cover comprising:
a cylinder;
a plurality of removable backing sheets disposed on the cylinder in a layered fashion, each backing sheet having a first surface and a second surface; and
a layer of adhesive substantially covering the first surface of each backing sheet;
wherein the cylinder is adapted to releaseably couple with a roller portion of a paint roller frame.

12. The adhesive roller of claim 11, wherein the plurality of backing sheets are disposed on the cylinder in a spiral-wound fashion.

13. The adhesive roller of claim 11, wherein the plurality of backing sheets are disposed on the cylinder in a straight-wound fashion.

14. A method of finishing a surface comprising the steps of:
providing a substrate having a surface;
providing a roller assembly having a handle;
providing an adhesive roller adapted to releasably couple with the roller assembly, the adhesive roller including a plurality of layers of adhesive-coated sheets, the adhesive coating being disposed on the outside of each of the sheets and the sheets being separated by perforations;
providing a roller cover;
providing a surface finish;
coupling the adhesive roller with the roller assembly;
rolling the adhesive roller on the surface to remove loose material from the surface;
removing the adhesive roller from the roller assembly;
installing the roller cover; and
applying the surface finish to the surface using the roller assembly with the roller cover.

15. The method of claim 14, wherein the step of rolling the adhesive roller on the surface to remove loose material on the surface includes removing at least one of the layers of adhesive-coated sheets to expose an unused adhesive-coated sheet.

16. The method of claim 14, wherein the surface of the substrate has been painted.

17. The method of claim 14, wherein the surface of the substrate is unfinished wood.

18. The method of claim 14, wherein the substrate is at least one of the group consisting of a wall, a ceiling, and a piece of furniture.

19. The method of claim 14, further comprising the steps of:
removing the roller cover from the roller assembly;
installing the adhesive roller onto the roller assembly; and
rolling the adhesive roller on the surface to remove loose material from the surface.

20. The method of claim 19, further comprising the steps of, subsequent to applying the surface finish:
providing an abrasive comprising at least one of the group consisting of sand paper and steel wool; and
abrading the surface finish using the abrasive.
